(19) United States
(12) Patent Application Publication
(10) Pub. No.: US 2019/0087919 A1
(43) Pub. Date: Mar. 21, 2019

(54) INTERFACE THAT PROVIDES SEPARATE DATA ENTRY AND DATA PRESENTATION IN A MANUFACTURING ENVIRONMENT

(71) Applicants: Terrance Holbrook, Bountiful, UT (US); Chad Milito, Ogden, UT (US)

(72) Inventors: Terrance Holbrook, Bountiful, UT (US); Chad Milito, Ogden, UT (US)

(21) Appl. No.: 15/937,320

(22) Filed: Mar. 27, 2018

Related U.S. Application Data
(60) Provisional application No. 62/560,322, filed on Sep. 19, 2017.

(51) Int. Cl. G06Q 50/04; G06Q 10/10; G06F 17/21; G06F 17/24

(52) U.S. Cl. CPC G06Q 50/04; G06Q 10/10; G06F 3/0481; G06F 17/245; G06F 17/212

(57) ABSTRACT

Embodiments are directed to methods and systems for iteratively collecting and transforming data. In one scenario, a computer system instantiates a software application that tracks the progress of a manufacturing process. The software application receives inputs from a first set of workers associated with the manufacturing process. The inputs are related to a given iteration of a process phase and are provided in a manner that is expected by the first set of workers. The computer system also receives a request to present the iteratively collected data received in the inputs in a second different manner, and generates a representation of the data which includes a report on the specified iteration of the manufacturing process phase. The computer system presents the report to a second, different set of workers, which allows the workers to consume the report in a manner expected by the second set of workers.

### CROSS-REFERENCE TO RELATED APPLICATIONS

This application claims priority to and the benefit of U.S. Provisional Application Ser. No. 62/560,322, filed on Sep. 19, 2017, entitled “Interface that Provides Separate Data Entry and Data Presentation in a Manufacturing Environment,” which application is incorporated by reference herein in its entirety.

### BACKGROUND

Manufacturing and production processes can be lengthy and complex, often involving many different steps, perhaps performed at different locations. Each of these manufacturing steps may be performed independently of the other steps, or may be dependent on the successful completion of specific steps. Traditionally, manufacturing and production processes were carried out by workers who inputted data regarding each step of the process. However, because quality control personnel prefer to see the process-related data in tabular form, the workers are often forced to input the data into tables, instead of using the process input forms they would prefer to use.

### BRIEF SUMMARY

Embodiments described herein are directed to methods and systems for iteratively collecting data in a first manner and transforming the collected data for presentation in a second different manner. Embodiments are also provided which allow users to navigate between phase forms and table view modes. In one embodiment, a computer system instantiates a software application configured to track the progress of a manufacturing process. The computer system iteratively collects data at the software application, where the data corresponds to inputs from a first set of workers associated with the manufacturing process. The inputs are related to a specified iteration of a manufacturing process phase, and are provided in a first manner that is expected by the first set of workers.

The computer system next receives a request to present the iteratively collected data in the second, different manner. In response, the computer system generates a representation of the iteratively collected data in the second different manner, where the representation includes a report on the specified iteration of the manufacturing process phase. The computer system also presents the report to a second, different set of one or more workers, allowing the second set of workers to consume the report in the second manner expected by the second set of workers. In some embodiments, the first set of workers are manufacturing process workers that monitor and facilitate production of the products, and the second set of workers are quality control workers that monitor manufacturing processes to ensure compliance with standards.

In another embodiment, a user interface is provided. The user interface includes a first interactive presentation window that presents batch records for a product that is being manufactured. The batch record itself includes multiple manufacturing phases. The user interface also includes an interactive button which, when activated, allows navigation between the batch records for the product being manufactured, as well as a second interactive presentation window having a phase looper table that allows users interacting with the phase looper table to initialize a phase bouncer view. The phase bouncer view is configured to filter batch records corresponding to the product being manufactured down to each manufacturing phase that is looped, thereby allowing users to navigate between similar manufacturing phases for each manufacturing batch.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including iteratively collecting data in a first manner and transforming the collected data for presentation in a second different manner.

FIG. 2 illustrates an example flowchart of a method for iteratively collecting data in a first manner and transforming the collected data for presentation in a second different manner.

FIG. 3 illustrates an example of a user interface that allows users to navigate between phase forms and table view modes.

FIG. 4 illustrates an interface in which a first worker iteratively provides information related to a manufacturing process in a manner preferred by the first worker.

FIG. 5 illustrates an interface in which a second worker views the information related to the manufacturing process in a tabular form preferred by the second worker.

FIG. 6 illustrates an interface in which a worker navigates from a tabular view to a step view.

FIG. 7 illustrates an interface that provides a step view illustrating which processes are open.

FIG. 8 illustrates an interface that allows workers to input information for a given process phase.

FIG. 9 illustrates an interface that allows workers to share locations on a phase.

FIG. 10 illustrates an interface that allows workers to select a marker and choose users that satisfy a given requirement for a type of action.

FIG. 11 illustrates an interface that provides a notification that a user has been given a shared link by another user.

FIG. 12 illustrates an interface that provides access to a selected phase and requested verification step.

### DETAILED DESCRIPTION

As noted above, embodiments described herein are directed to methods and systems for iteratively collecting data in a first manner and transforming the collected data for presentation in a second different manner. Embodiments are also provided which allow users to navigate between phase forms and table view modes. In one embodiment, a computer system instantiates a software application configured to track the progress of a manufacturing process. The computer system iteratively collects data at the software application, where the data corresponds to inputs from a first set of workers associated with the manufacturing process. The inputs are related to a specified iteration of a manufacturing process phase, and are provided in a first manner that is expected by the first set of workers.

The computer system next receives a request to present the iteratively collected data in the second, different manner. In response, the computer system generates a representation of the iteratively collected data in the second different manner, where the representation includes a report on the specified iteration of the manufacturing process phase. The computer system also presents the report to a second, different set of one or more workers, allowing the second set of workers to consume the report in the second manner expected by the second set of workers. In some embodiments, the first set of workers are manufacturing process workers that monitor and facilitate production of the products, and the second set of workers are quality control workers that monitor manufacturing processes to ensure compliance with standards.

In another embodiment, a user interface is provided. The user interface includes a first interactive presentation window that presents batch records for a product that is being manufactured. The batch record itself includes multiple manufacturing phases. The user interface also includes an interactive button which, when activated, allows navigation between the batch records for the product being manufactured, as well as a second interactive presentation window having a phase looper table that allows users interacting with the phase looper table to initialize a phase bouncer view. The phase bouncer view is configured to filter batch records corresponding to the product being manufactured down to each manufacturing phase that is looped, thereby allowing users to navigate between similar manufacturing phases for each manufacturing batch.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

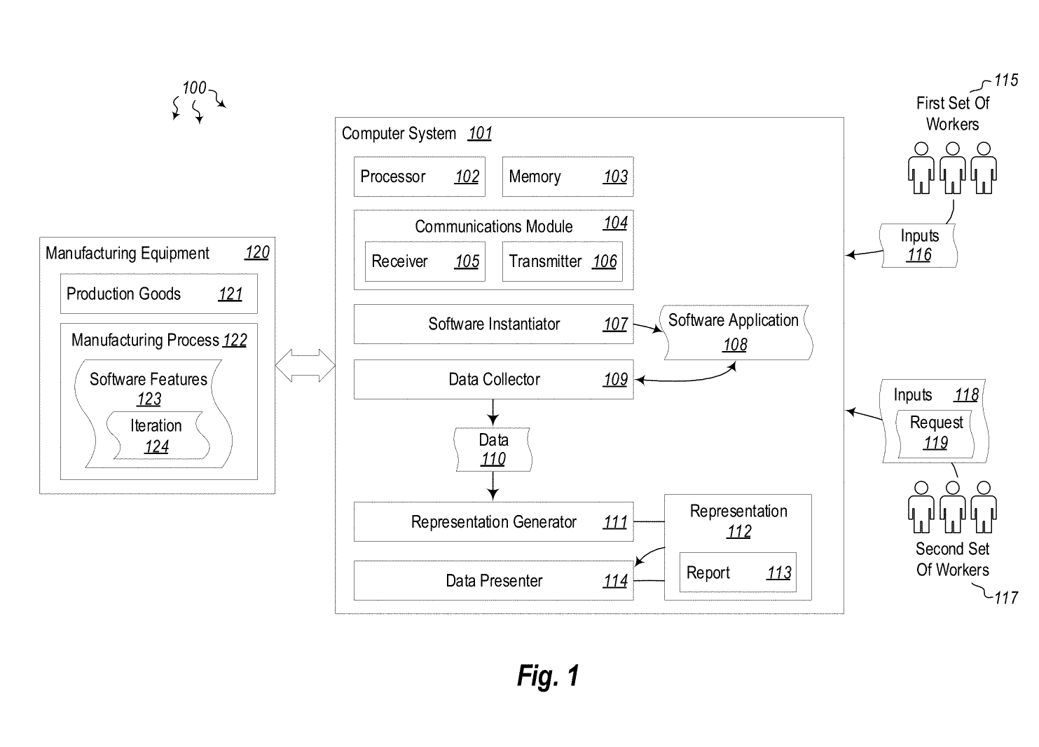

Turning now to FIG. 1, a computing architecture 100 is provided which at least one embodiment described herein may be employed. The computing architecture 100 includes a computer system 101. The computer system 101 includes at least one processor 102 and at least some system memory 103. The computer system 101 may be any type of local or distributed computer system, including a cloud computer system. The computer system 101 includes modules for performing a variety of different functions. For instance, the computer system 101 includes a communications module 104 with a receiver 105, a transmitter 106, or possibly a combined unit (i.e. a transceiver). These receivers and transmitters may be hardware radios such as WiFi, Bluetooth, cellular, global positioning system (GPS) or other types of radios.

The communications module 104 may be configured to communicate with other computer systems using different wired or wireless communication links. Indeed, the communications module 104 may include any wired or wireless communication means that can receive and/or transmit data to or from other computer systems. The communications module 104 may be configured to interact with databases, mobile computing devices (such as mobile phones or tablets), embedded or other types of computer systems.

The computer system 101 may also include modules, functions, kernels, or special-purpose processors designed to iteratively collect data in one manner and transforming the collected data for presentation in another manner. For instance, the computer system 101 includes a software instantiator 107 configured to instantiate a software application 108 that tracks progress of a manufacturing process. The software application may be a full application, or only a portion thereof (such as a function or applet, etc.). The software instantiator 107 is configured to initialize and run the application 108 on the computer system 101. In some cases, the software application is designed to monitor or control manufacturing equipment 120. The manufacturing equipment 120 may be substantially any type of manual or automated machine or tool that is used to produce some sort of production good 121. The manufacturing equipment may be associated with processing raw materials, creating goods using processed materials, packaging goods, distributing goods, or otherwise associated with the production of a product or service.

Typically, manufacturing processes (e.g. 122) used to create production goods 121 will have multiple different process phases 123. Each phase may include multiple steps and sub-steps that are performed to create the production goods 121. Each process phase may have multiple iterations 124. For example, if a couch needed four legs attached, each “attach leg” step would have its own iteration. Each iteration can be given a specific name (e.g. front left leg, right rear leg, etc.). Thus, using a series of process phases 123 and iterations 124, a fully built production good 121 can be produced. The computer system 101 may be communicatively connected to the manufacturing equipment 120, via wired and/or wireless connections, and may receive updates from the equipment as each manufacturing step is performed.

The data collector 109 of computer system 101 is configured to iteratively collect data 110 at the software application 108. The data 110 corresponds to inputs 116 from a first set of one or more workers 115. These workers 115 are associated with the manufacturing process 122 being performed at the manufacturing equipment 120. The data 110 may be collected iteratively, over time as it is provided by the workers 115. Workers of a first type may be conditioned to inputting the manufacturing data in a specific way. Indeed, many manufacturing processes are expensive, dangerous, time-sensitive and tightly-controlled. As such, each worker is taught to input data in a specific manner to be consistent. The data may come in in the form of numbers, words, symbols, mouse inputs, keyboard inputs, touch inputs, audio inputs, video inputs, gestures or other forms of input. The data collector 109 may be designed to gather multiple forms of input at once. In some cases, multiple people may be interacting with the same process phases 123 or the same iteration 124. These interactions may include different forms of input, each being iteratively collected and applied to a representation by the representation generator 111. Each input may be provided in a first manner that is expected by the first set of workers 115.

The receiver 105 of the communications module 104 may receive a request to present the iteratively collected data in a second, different manner. This request 119 may be a specific, explicit request, or may be an implicit request. For example, an explicit request would expressly request that the data 110 be presented in a different manner, while an implicit request may be part of an application instantiation request, or may be part of data input 118 from the second set of workers 117. In such cases, if an input is received from a worker in the second set, the computer system 101 assumes that the second worker wants to see the data 110 in a different format, and thus, the representation generator 111 is to generate the new representation 112 in the different format.

The representation generator 111 of computer system 101 thus generates representations 112 of the iteratively collected data 110 in a specified manner that is different than the first manner. At least in some cases, the representation is (or includes) a report 113 on the specified iteration 124 of the manufacturing process phase 123. The report 113 may be interactive, in that it not only allows the second set of workers 117 to view the data 110, it also allows the workers to interact with the data and find out more information regarding a given data item. For example, if a process phase is out of spec, or if a test was failed, or if production has halted, the workers 117 may be able to drill down and find out the causes behind the data. The first set of workers 115 may provide additional information regarding the data 110 as they provide input data 116. This data may then be accessible in a form expected by the second set of workers 117 (i.e. in the form of a report), where they can view, interact with or manipulate the data as needed.

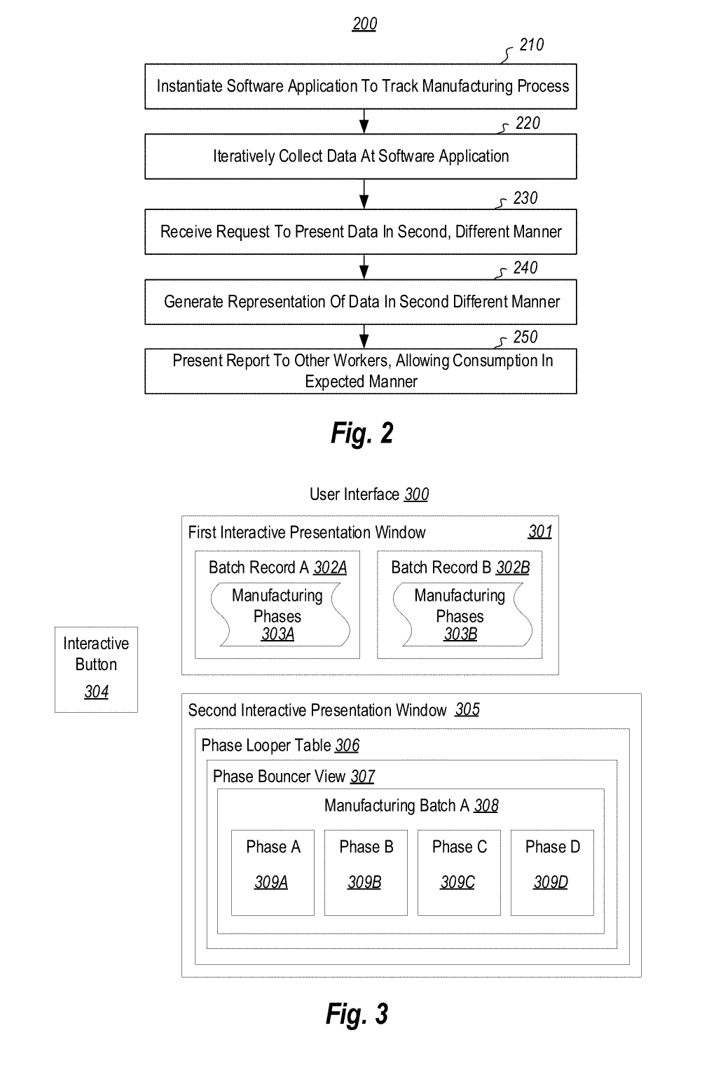

Once the representation 112 has been generated, the data presenter 114 presents the representation 112 and/or the report 113 to the second, different set of workers 117. This allows the second set of workers 117 to consume the report in the manner they expect, and interact with the report in the manner they expect. By not forcing the first set of workers to input the data in an unfamiliar manner, and by not forcing the second set of workers to view and interact with the data in an unfamiliar manner, many hours of computing resources including CPU cycles, memory, data storage and networking bandwidth can be spared. Instead of using all of those computing resources having the first workers 115 input the data in a manner that is highly inefficient, or having the second workers 117 view and manipulate the data in a manner that is both tedious and preventable, the embodiments herein allow those computing resources to be preserved and used for other things. These concepts will be explained further below with regard to the method 200 of FIG. 2, and the user interface (UI) embodiments of FIGS. 3-12.

In view of the systems and architectures described above, methodologies that may be implemented in accordance with the disclosed subject matter will be better appreciated with reference to the flow chart of FIG. 2. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for iteratively collecting data in a first manner and transforming the collected data for presentation in a second different manner. The method 200 will now be described with frequent reference to the components and data of environment 100.

Method 200 includes instantiating a software application configured to track the progress of a manufacturing process (210). For example, the software instantiator 107 may initialize software application 108 such that the application begins tracking the progress of a manufacturing process 122. The software instantiator 107 and any other modules or components of computer system 101 may include hardware, software, or a combination of hardware and software to perform certain functions. The software instantiator 107 accesses data structures, loads them into memory 103, initializes the processor 102 to begin executing the application, and performs other tasks necessary to launch the application including potentially initializing the communications module 104 to receive data from sensors or from remote data stores. Indeed, in some embodiments, the manufacturing equipment 120 that is performing the manufacturing process 122 to create production goods 121 may implement a variety of different hardware sensors. These hardware sensors provide readings regarding how different pieces of equipment are functioning.

Method 200 next includes iteratively collecting data at the software application, the data corresponding to inputs from a first set of one or more workers associated with the manufacturing process, the inputs being related to a specified iteration of a manufacturing process phase, the inputs being provided in a first manner that is expected by the first set of workers (220). The data collector 109 of computer system 101 iteratively collects data 110 at the software application 108. The data may include inputs 116 from workers 115. The inputs 116 may be related to one iteration of a manufacturing process phase. As indicated above, each manufacturing process may have multiple phases, or multiple iterations of the same process. Thus, if one task is performed over and over to create a ball bearing, for example, each creation of that ball bearing may have its own process phase iteration. The workers 115 are conditioned to enter the data in a certain manner that is representative of the current industry standard. Each manufacturing process has tight controls and specifications, and thus, the data input by the first set of workers 115 is also tightly controlled and, at least in some cases, cannot be changed.

Method 200 further includes receiving a request to present the iteratively collected data in a second, different manner (230). For example, the second set of workers 117 may send a request 119 requesting that the data 110 be presented in a different manner. In some cases, the request 119 is sent separately from the input 118, and in other cases, the request is implied when inputs are received from the second set of workers. Upon receiving the request 119, the representation generator 111 generates a representation of the iteratively collected data in the second different manner (240). The representation 112 includes a report 113 on the specified iteration of the manufacturing process phase. In the embodiments herein, the second set of workers 117 needs to see the data 110 in a format that is different than that input by the first set of workers. The representation generator 111 generates the representation 112 in a manner that is understandable by the second set of workers.

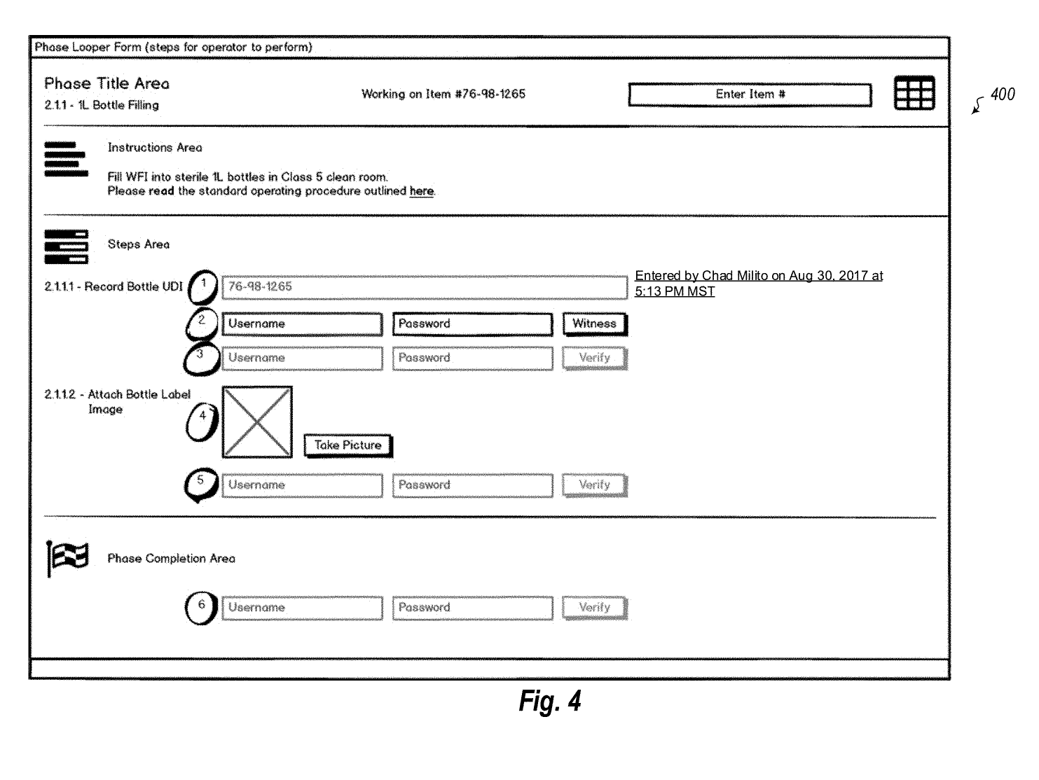

Once the representation 112 has been generated, it is presented to the second, different set of workers 117, allowing the second set of workers to consume the report in the second manner expected by the second set of workers (250). For example, as will be shown below with regard to FIGS. 4-12, various types of reports, and various ways of navigating those reports will be described in greater detail.

Turning now to FIG. 3, a user interface 300 is provided for interaction with the software application 108 of FIG. 1. In one embodiment, a computer-readable medium is provided that stores computer-executable instructions which, when executed, instantiate the user interface 300. The user interface includes a first interactive presentation window 301 that presents batch records (e.g. 202A, 202B) for a product that is being manufactured (e.g. production good 121). The batch records include multiple manufacturing phases (e.g. 203A, 203B) for each batch record.

The user interface 300 also includes an interactive button 204 which, when activated, allows navigation between the batch records (202A/202B) for the product being manufactured. Using such a button or other interactive user interface element, a user may quickly and efficiently navigate between different batch records to view information or make changes to the records. As further shown in FIG. 3, the user interface 300 includes a second interactive presentation window 305. This second window 305 includes a phase looper table 306 that allows users interacting with the phase looper table to initialize a phase bouncer view 307 that is configured to filter batch records (e.g. 302A/302B) corresponding to the product being manufactured down to each manufacturing phase (e.g. 309A-309D) that is looped. This allows users to navigate between similar manufacturing phases for each manufacturing batch (e.g. 308.

Thus, for example, manufacturing batch A (308) may have one or more phases 309A-309D. The phase looper table 206 provides a phase bouncer view 307 that allows users to “bounce” or switch between different manufacturing phases. Thus, in the phase bouncer view 307, the user could easily switch from Phase B (309B) to Phase D (309D) to Phase C (309C) or to other phases. The phase looper table 306 filters batch records (of which there may be hundreds or thousands) leaving only those manufacturing phases that are relevant to the product being manufactured. As one skilled in the art will appreciate, this approach greatly simplifies the viewing of batch records and their corresponding phases. Moreover, the ability to “bounce” between phases greatly reduces the amount of time spent by users that interact with the user interface 300. Further still, the reduced user interaction time also reduces consumption of computing resources that would have otherwise been used to perform manual navigations between batch records and phases. The phase bounce view thus provides a way of automating a task that was previously not automated in the industry.

In some embodiments, the filtered, phase bouncer view 307 defaults to the type of table the user was previously working on, allowing the user to continue the same job on a new batch. Thus, in this embodiment, if a user was working with one type of phase looper table 306 for a given production good, and the user switches to another type of production good, the phase looper table will default to the type used with the previous production good. This allows the user to begin the same type of work on a new batch (e.g. 308). The user can repeat this process multiple times in order to complete the same task on multiple different batches.

In some cases, the user may be able to provide an input at the user interface 300 indicating that an identifier has been scanned. The identifier may be a bar code, QR code or some other type of symbol or code that is electronically recognizable by a code scanner. After the code has been scanned, the user interface may automatically navigate to a specific step in the process phase based on the scanned identifier. Thus, navigation via code may also be used. Furthermore, the phase bouncer view 307 may be customizable. In cases where the phase bouncer view is customizable, it may be configurable to navigate to those process phases that fit certain criteria. For example, it may navigate to those process phases that are currently running, or are currently having problems, or meet another criteria established by the user. Once the application has navigated to the appropriate phase form, the user may use the graphical user interface 300 to view various windows (e.g. 306, 307) that allow corrections to be made to the selected process phases. These corrections may indicate that a part is out of tolerance, or that other issues have occurred with the production of that part.

FIG. 4 illustrates a user interface 400 that includes a form for entering information relating to a manufacturing (or other) process. As noted above, the term process or “process phase” refers to a series of steps that are performed in order to manufacture an item. Each process phase may be part of an operation, which itself is part of a procedure or unit procedure. Each process phase outlines steps that are to be performed and verified by different people. For example, in FIG. 1, a phase form 400 is provided for filling a bottle (2.1.1) (e.g. with a liquid). The form provides an instructions area that describes how the steps are to be performed, a steps area that shows two steps (2.1.1.1—Record Bottle UDI and 2.1.1.2—Attach Bottle Label Image) that are to be performed, along with indications of who performed the steps and what the product looked like at that stage, and a phase completion area that allows a worker to sign off on completion of the steps.

Each process phase may have multiple iterations for the same part. For example, if 5,000 of the same part are to be manufactured, the process phases for that part are iterated 5,000 times. Thus, in this example, the process phases for filling a bottle would be performed 5,000 times. This group of processes would be referred to as a batch. Each iteration in the batch may be tracked separately, as the production of each part or the performance of each step may have its own issues or complications, may have its own workers, its own source materials, etc. Accordingly, each iteration (i.e. each part) has its own iteration number, as shown on top of the form 400 in FIG. 4. This form may be referred to as a “phase form” herein. Manufacturing workers may be familiar with this type of form, which may be used to input information into these forms.

In the embodiments herein, these workers may continue inputting information into these forms, and do not need to worry about the tabular forms desired by the quality control personnel. Indeed, many current software solutions try to force manufacturing workers to input the process information into tabular quality control forms. These forms are often confusing, and do not allow for revisions or corrections. In the embodiments herein, the manufacturing workers may input the information in familiar phase forms, and a looper process or looper algorithm will generate the quality control tabular forms or “inspection tables” herein.

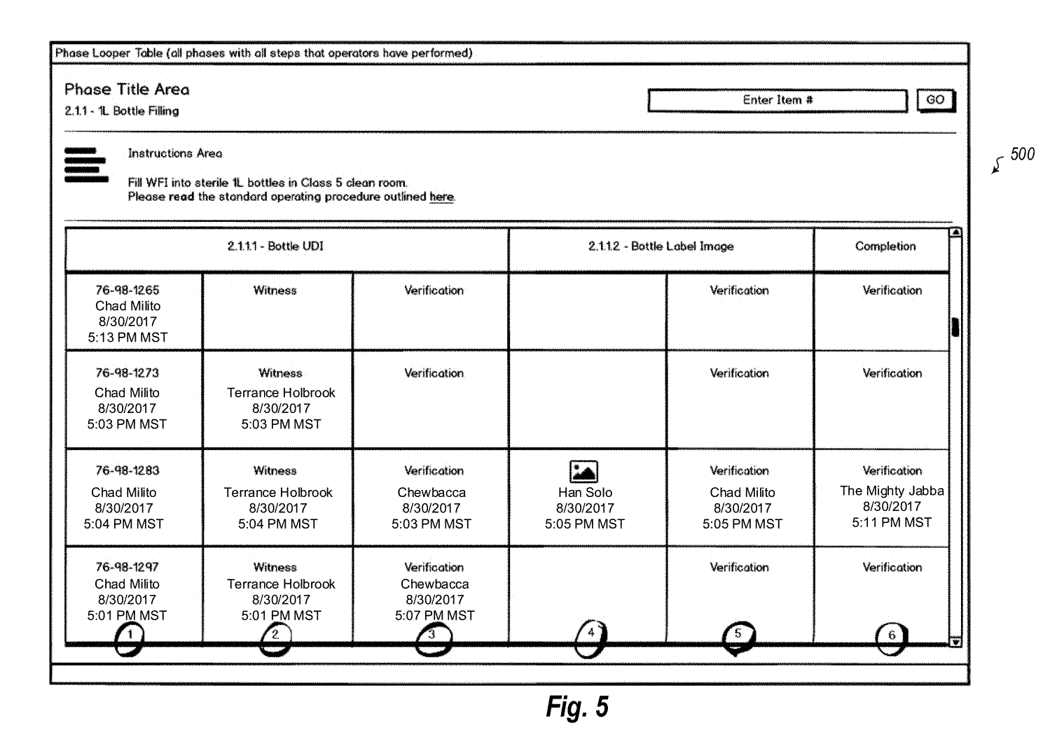

As shown in FIG. 5, the inspection tables may have one row per phase form (i.e. one row for each iteration of the phase form). The looper algorithm accesses the phase forms and fills out each of the corresponding rows in the inspection table. In the example shown in form 500 of FIG. 5, a quality control worker can switch between items by scanning in (or otherwise providing) the item's associated identifier (e.g. a number or code) and the interface will switch to the data collected for that item number. If it is the first time that item number has been accessed, the looper algorithm will automatically record the data in the key field as noted by 2.1.1.1. A phase form builder, which is part of the interface, would mark which step has the key field entry for the user executing the batch.

As shown in FIG. 1, a button or other link may be provided in the interface which, when selected, allows a user to enter a table view mode. The phase form view of FIG. 4 is a single row from the table of FIG. 5. The looper algorithm loops through the phase forms and creates new rows for each phase form in the table view mode. Clicking a row in the table view mode takes the user to that item number's form. The cell that the user clicks on within the row will highlight that step on that form. Within the form, the user may proceed to make corrections or changes, which are tracked according to time and user. These corrections are then propagated to the table view mode of FIG. 5. The table view mode thus shows current progress across all items in the batch.

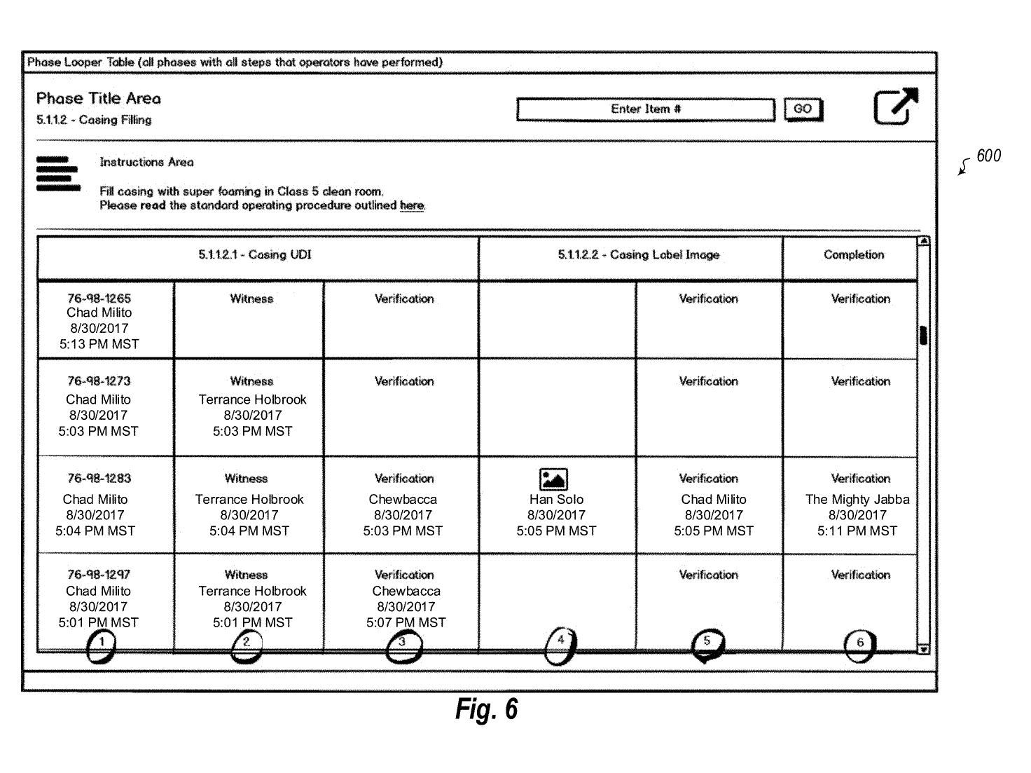

FIG. 6 illustrates a user interface 600 in a table view mode. Within this table view mode, a quality control person may be able to “bounce” or navigate between batch records for products that are on the manufacturing lines. For example, a quality control person may need to find the next quality control type inspection table (phase looper form) to work on. As such, when they are working on one phase looper table, they can then “bounce” to a phase bouncer view that will filter all the batch records down to each phase that is looped. The filtered view may default to the type of table the user was just working on, so the user can simply continue the same job on a new batch.

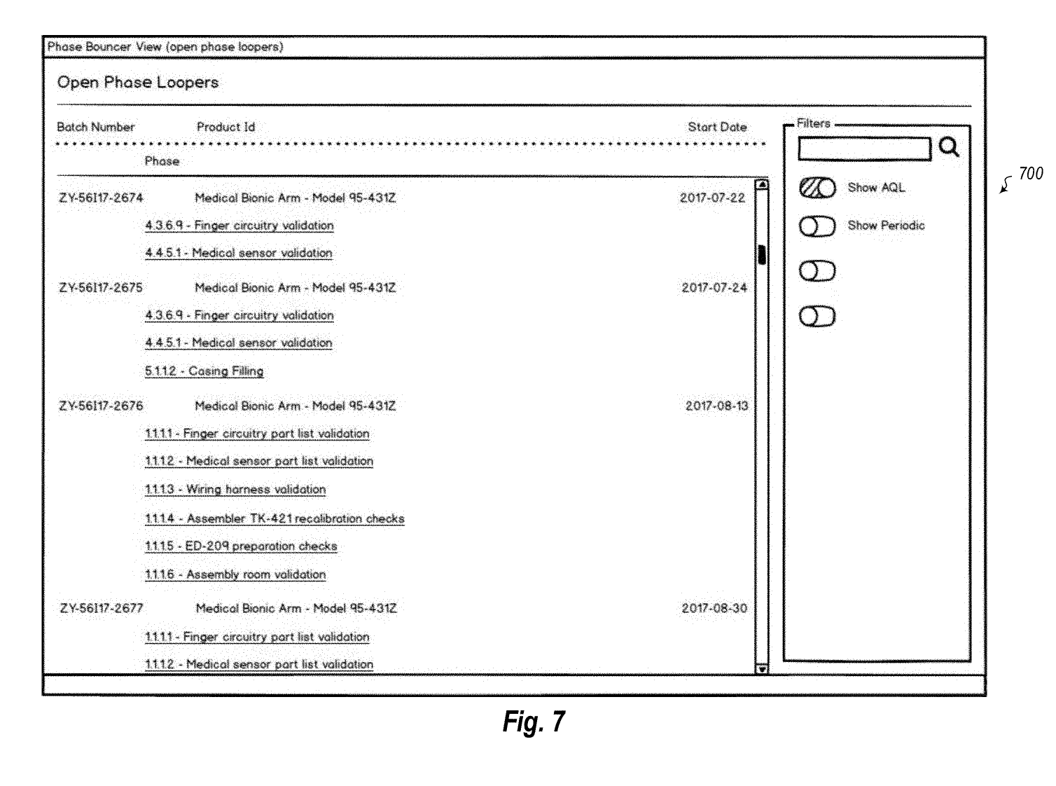

Within the phase bouncer view (generally shown in for 700 of FIG. 7), the user can also turn on other table types if the user wants to switch roles, etc. For example, clicking on a hyperlink would bounce the user back into the phase looper form where they can start capturing more validation data on that batch. This reduces complexity for the quality control worker to simply use the “Phase Bouncer” button to go to the next “Phase Looper” to work on. This reduction in complexity greatly reduces the amount of code that needs to be written to accomplish this purpose, and further reduces the amount of CPU cycles used to complete these tasks.

As is indicated in the notes of FIG. 7, only the open phase loopers that can be worked on by the user are shown in the phase bouncer view. Thus, users with different rights or different roles will see different sets of open phase loopers. Various filters may be applied to the list to make it more relevant to the task the user is trying to perform. The phase bouncer view may be designed to default to the type of looper the user was last using.

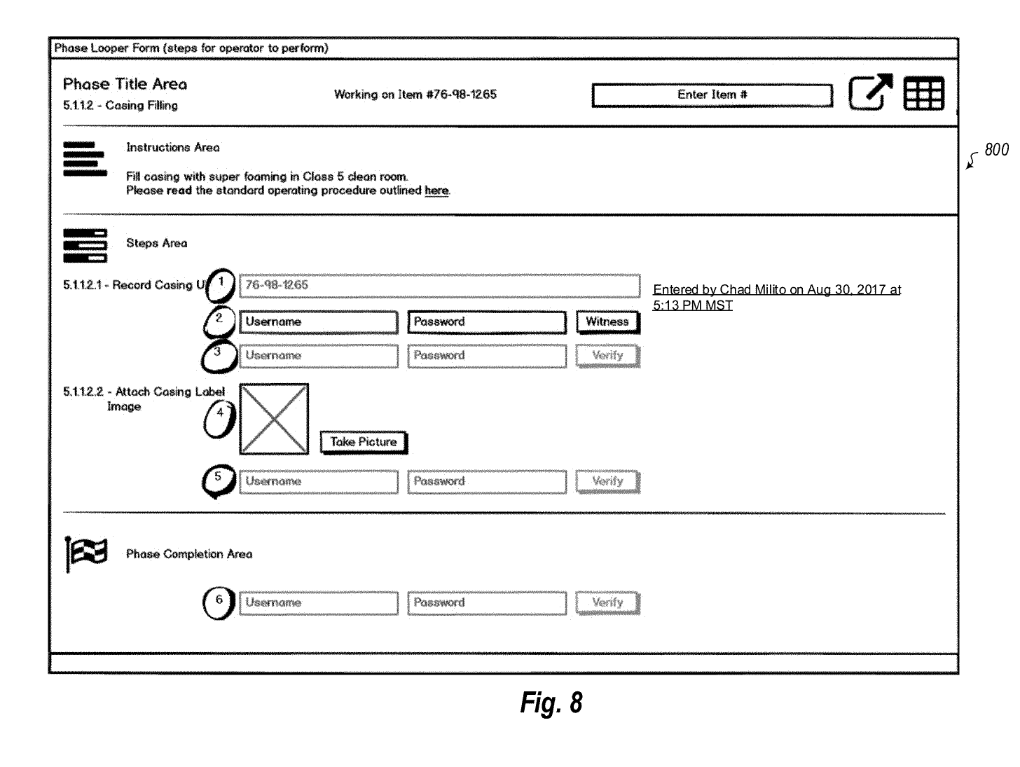

The numerals 1-6 shown in the bottom row of the table in FIG. 6 correspond to the numerals 1-6 shown in the phase form view of FIG. 8. The inspection tables of FIG. 6 have one row per phase form, and the looper accesses each phase form in the batch (or a specified subset thereof) to fill out information in each of the rows. In the example 800 of FIG. 8, a user may be able to switch between items by scanning in the manufactured part's item number and the system will switch to the data collected for that item number. As shown in 5.1.1.2.1, if it is the first time the item number has been accessed, the system will automatically record the data in that key field. The phase form builder would mark which step has the key field entry for the user executing the batch. The form includes two buttons for phase bouncer mode and table view mode. Other buttons may be provided for navigating between views.

Thus, in this manner, a first type of user (e.g. a manufacturing worker) may be able to provide input regarding manufacturing process phases in the manner they are used to (e.g. using phase forms). A second type of user (e.g. a quality control user) may be able to simply select a button to initiate a looper algorithm that analyzes data in various phase forms and presents it in a table view mode familiar to the quality control user. Thus, each type of user can operate in the manner they are familiar with, without forcing one type of user to input or consume the data in an unfamiliar way. The systems and methods described herein greatly simplify previous attempts at solving this disjunction which attempted to create a tabular interface into which the manufacturing worker would directly input the data. In such previous tabular systems, users could not navigate to original forms and make changes or verify changes. Moreover, users could not provide passwords, pictures, bar codes or other data using the tabular view. Thus, new types of navigation are provided that were not available previously, and new types of data can be provided that could not be provided in previous solutions.

In the present application, a software coding bridge is provided that combines the two above-described disparate data input and consumption systems. It is simpler to code, is scalable, and allows each type of worker to remain in his or her idiom. Users can also deal with corrections or changes in a much easier manner, as such changes can be made directly in the source phase forms, which are accessible using the phase bounce feature provided in the table view mode.

In some embodiments, separate tabular representations may be generated for each batch of the phase. As shown user interface 600 of FIG. 6, each batch may include multiple iterations of a phase process. Each phase process may have multiple data points (e.g. 1-6). These information points are gathered from the phase form 800 of FIG. 8, and are shown in corresponding columns for a given row. Thus, a user (such as a factory worker or supervisor) can enter or sign off on data in a view that is standard for that user. As the user enters the data, it is iterated by the system and preserved so that when the user wants to see it, the table view mode can be generated dynamically on the fly.

A second type of user (such a quality control worker) may view the dynamically generated table view in a manner that is standard for that type of worker. The table may be part of a report that includes one or more quality control tables representing quality control parameters for each part of the manufacturing process. Either type of user may be able to navigate between views using the phase bouncer feature. Using this feature, users may view each process phase, along with its corresponding series of steps. Each of these steps may have its own associated workflow, and each workflow may have sub-workflows. Each of these workflows may be visible in the phase form view, and each may be modified by the user. The looper algorithm can loop at any level of the workflows, and can populate data fields in the table view mode as it loops.

Each process phase may have a loop bouncer that allows users to navigate between items in the phase workflows. The loop bouncer may be a customizable portion of software code that is specific to a given phase, or is generalized to work with many different phases. The loop bouncer may be configured to navigate to those process phases that are currently running, or are currently having problems, or meet some other criteria established by the user. Once navigated to the phase form, the user may use a graphical user interface to view various windows that allow corrections to be made to the process phases. These corrections may indicate that a part is out of tolerance, for example, or that other issues have occurred with the production or processing of that part.

In some embodiments, a user may be able to use a scanner to scan an identifier for a part or other item of manufacture and navigate to a specific step in the process phase for that part. At this point, the user could provide new information or alter previously existing information regarding the manufacturing of the part. The systems herein allow users to make corrections or add samples from products being manufactured or make other changes to each manufacturing process phase. Users can also select a workflow and see details related to that workflow. Within the details view, the user can make changes to the workflow if desired, or add (or remove) sub-workflows under the selected workflow.

The embodiments herein may be used by many users at the same time. Indeed, the applications and interfaces described herein support multiple simultaneous users across unit procedures, across operations, and across process phases. Multiple users may access the same phase form or the same table view mode and attempt to make changes thereto. The embodiments are designed to prevent data clashes, even with multiple simultaneous users. Each user's inputs may be instantly applied across multiple iterations of a phase process. This allows implementation in large manufacturing scenarios in which many workers are on the job analyzing processes and making changes.

In some cases, these workers may make changes to manufacturing process phase parameters on the fly, as parts are being manufactured. These changes to the manufacturing process phase parameters may directly control operation of manufacturing equipment involved in the manufacturing process. Thus, the users' inputs can directly control how a given machine or device operates during the manufacturing process. The manufacturing process phase parameters may control, for example, how long a given machine is turned on, how hot or cold it runs, how fast or slow it runs, which materials it uses, which outputs are produced, or may control other parameters of the machine.

As items are manufactured, reports are generated describing the controls, operations and parameters of the production phase. The reports may include a quality control table representing quality control parameters for the manufacturing process. Each manufacturing process may thus be monitored and controlled according to these quality control parameters that are designed to ensure that each item is being manufactured with a sufficiently high level of quality. Graphical user interfaces may be provided that allow users to view and change these quality control parameters. The user interface may also provide windows that allow notations and corrections to be made to different elements of existing manufacturing process phases.

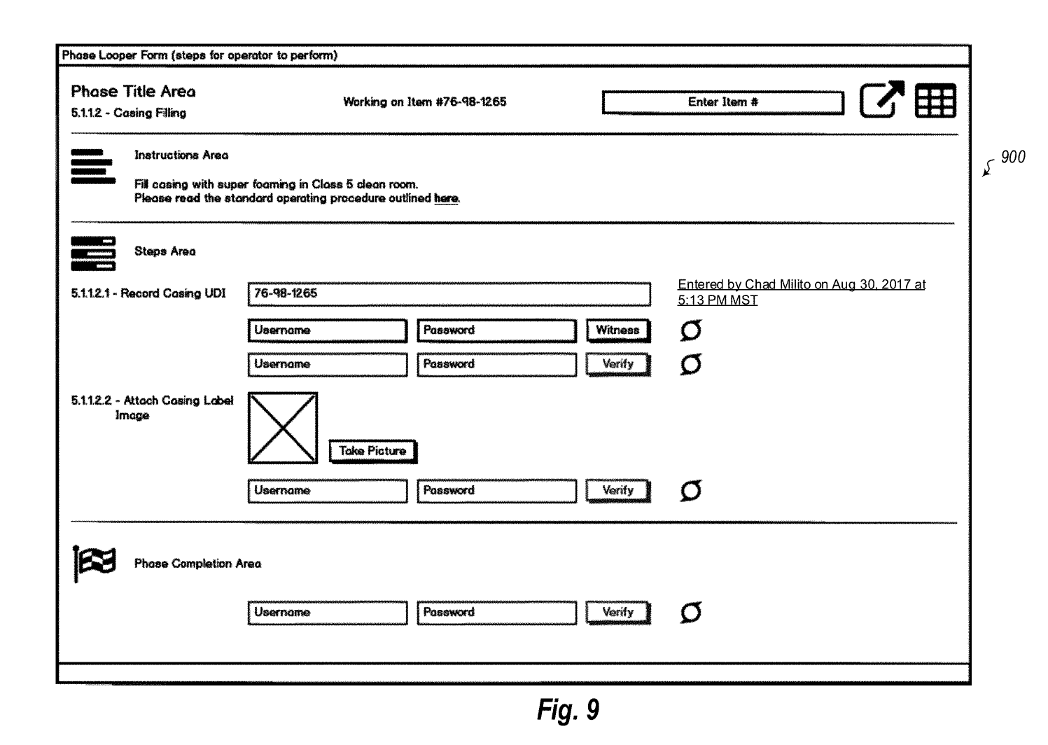

FIGS. 9-12 illustrate user interfaces that provide unique methods of navigating between and filling out electronic batch records. User interface 900 of FIG. 9, for example, provides unique functionality including buttons or other interactive elements that navigate the user to a particular screen that allows a user to resolve a current issue. For instance, assume that the user has entered in the requested data (as shown with “76-98-1265”) for a record casing and is waiting for someone to verify and/or witness their work. The witness may be there watching but may not want to apply their e-signature sign off on the data entry terminal (e.g. to prevent saving their password within from the data entry web browser). The human verifier may not be present and may show up later to verify data entry. Both want to quickly find the right location every time when witnessing or verifying.

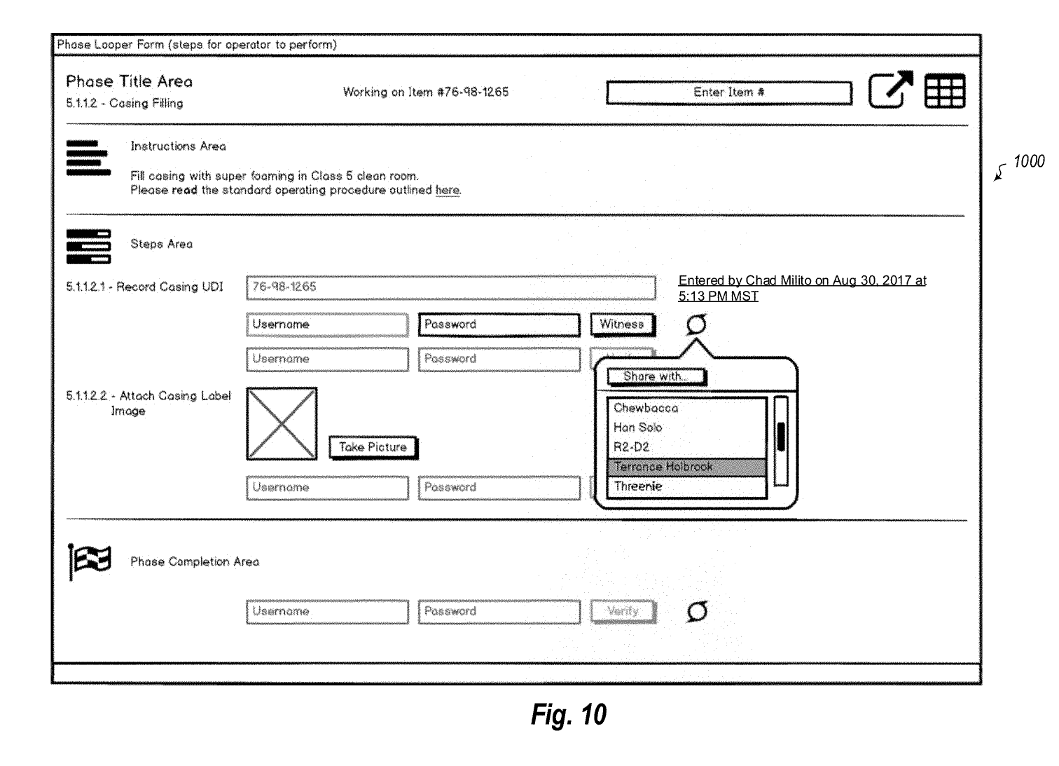

Interactive buttons allow the witnessing and verifying to be shared with other users, as shown in user interface 1000 of FIG. 10. A data entry user can click on the marker (i.e. the interactive button) and choose from the list of available users that satisfy requirements for that type of action (verification or witness). Thus, in the “Share with . . . ” list of user interface 1000, only those users or entities that satisfy a given set of criteria will be shown in the list. Upon selecting a user, that user will receive a notification that a given manufacturing step has been witnessed or verified, or that the step needs to be witnessed or verified by the user to whom the notification was sent.

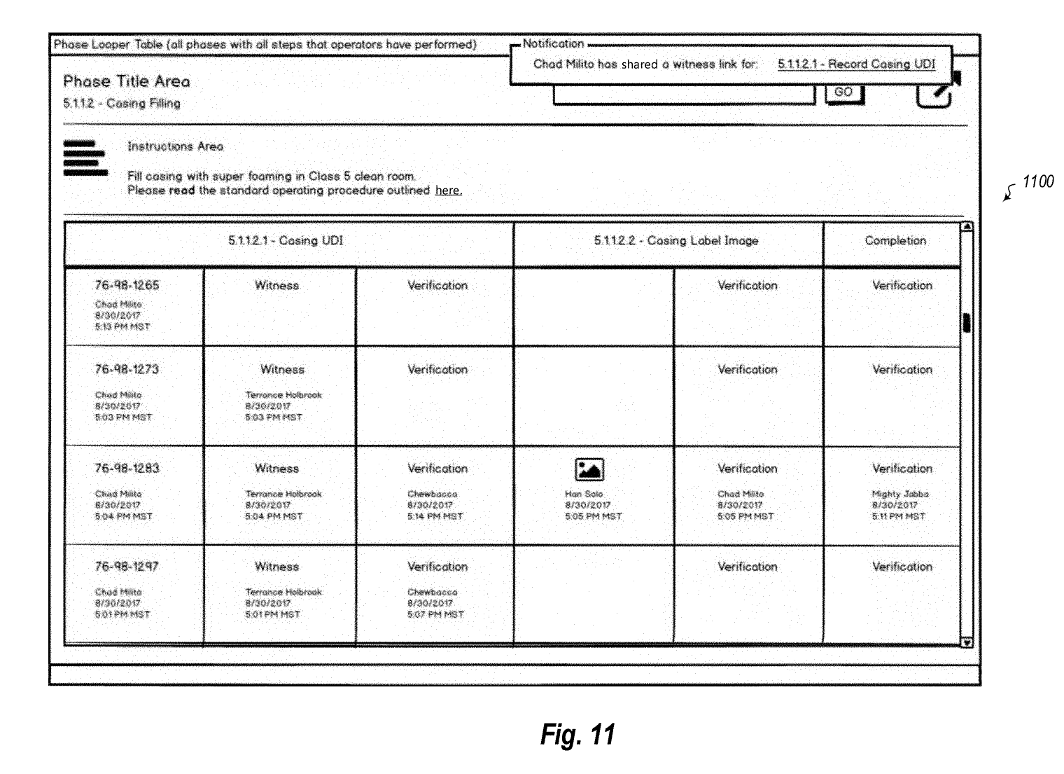

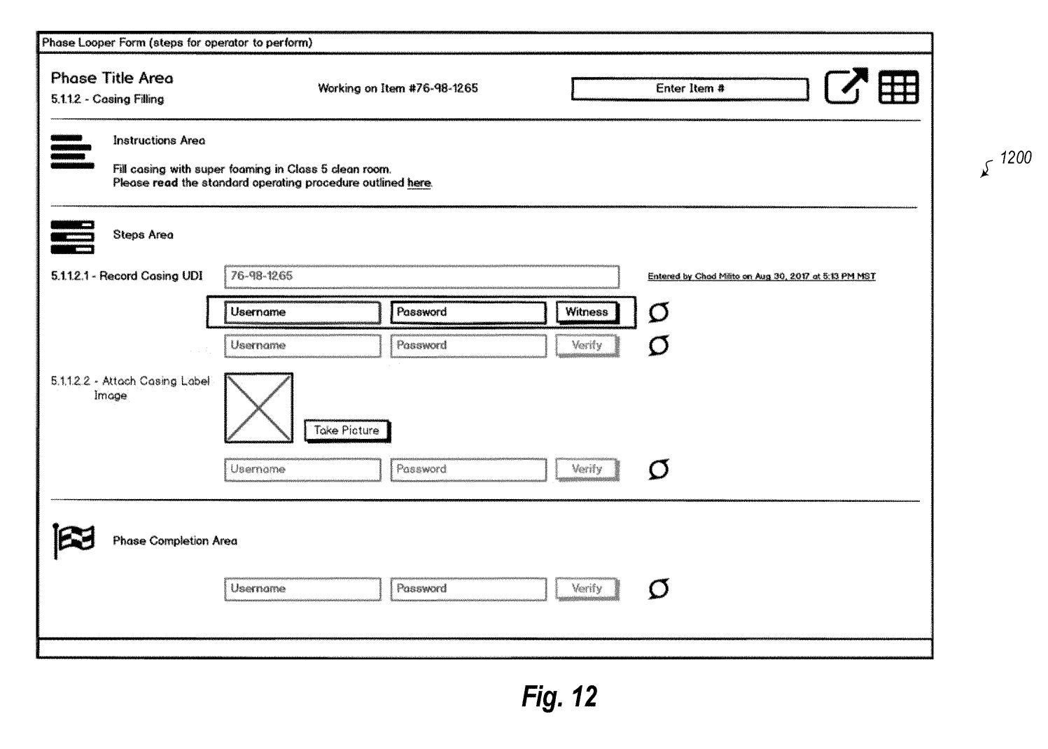

For example, in user interface 1100 of FIG. 11, a notification states that “Chad Milito has shared a witness link for: 5.1.1.2.1—Record Casing UDI.” The notification is itself a link to that phase. If a user selects that link, the user is then sent to that phase, as shown in user interface 1200 of FIG. 12. Once the user has been navigated to the linked phase, the step requested for verification or witness (or the previously completed step) is highlighted for the user to view or to sign off once the data is verified or witnessed. In this manner, users can share links between phases to communicate which steps need to be done, or sharing steps that have been performed with parties that need to know. This process can also be used outside of the verification and witness roles. For example, several people may be working on a particular phase, perhaps simultaneously. In such cases, one can share the phase with other users that will assist with the various data entry and other steps. Thus, if any one step is acting as a bottleneck in the manufacturing process, users can notify data entry personnel, witnesses, verifiers, managers or other users that certain work needs to be performed to alleviate the bottleneck. Direct links to the processes or steps that need to be performed allow users to select the link and perform the work. This results in a much greater efficiency both in navigating between phases and in alleviating manufacturing process bottlenecks that prevent factories from producing at full capacity.

Thus, in this manner, methods and systems are provided which iteratively collect data in one manner and present the collected data in another manner. Moreover, methods and systems are provided which allow users to navigate between phase forms and table view modes. The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one processor, for iteratively collecting data in a first manner and transforming the collected data for presentation in a second different manner, the method comprising:
instantiating a software application configured to track the progress of a manufacturing process;
iteratively collecting data at the software application, the data corresponding to inputs from a first set of one or more workers associated with the manufacturing process, the inputs being related to a specified iteration of a manufacturing process phase, the inputs being provided in a first manner that is expected by the first set of workers;
receiving a request to present the iteratively collected data in a second, different manner;
generating a representation of the iteratively collected data in the second different manner, the representation comprising a report on the specified iteration of the manufacturing process phase; and
presenting the report to a second, different set of one or more workers, allowing the second set of workers to consume the report in the second manner expected by the second set of workers.

2. The method of claim 1, wherein the inputs from the first set of workers are designed to make changes to one or more manufacturing process phase parameters of the specified iteration of the process phase.

3. The method of claim 2, wherein the manufacturing process phase parameters directly control operation of one or more pieces of manufacturing equipment involved in the manufacturing process.

4. The method of claim 1, wherein the representation generated in the second different manner comprises a tabular representation generated for one or more batches of the manufacturing process phase.

5. The method of claim 1, wherein the first set of workers includes a specific type of manufacturing process workers, and wherein the first set of workers enters the input data in a view that is an established standard for that specific type of worker.

6. The method of claim 1, wherein the second set of workers includes a second, different type of manufacturing process workers, and wherein the second set of workers views the presented data in a view that is standard for the second set of workers.

7. The method of claim 1, wherein the report comprises a quality control table representing quality control parameters for the manufacturing process.

8. The method of claim 1, wherein each manufacturing process phase includes a series of steps, and wherein each step has an associated phase workflow describing how the steps are to be completed.

9. The method of claim 8, wherein each process phase form has a loop bouncer that allows the first or second set of workers to navigate between items in the phase workflows.

10. The method of claim 1, wherein the loop bouncer is customizable based on which process phases are currently running within the manufacturing process.

11. The method of claim 1, wherein the software application further includes a graphical user interface that provides one or more windows that allow notations and corrections to be made to existing manufacturing process phases.

12. One or more computer-readable media that store computer-executable instructions which, when executed, instantiate a user interface, the user interface comprising the following:
a first interactive presentation window that presents one or more batch records for a product that is being manufactured, the batch records including a plurality of manufacturing phases;
an interactive button which, when activated, allows navigation between the one or more batch records for the product being manufactured;
a second interactive presentation window comprising a phase looper table that allows users interacting with the phase looper table to initialize a phase bouncer view that is configured to filter batch records corresponding to the product being manufactured down to each manufacturing phase that is looped, thereby allowing users to navigate between similar manufacturing phases for each manufacturing batch.

13. The computer-readable media of claim 12, wherein the filtered, phase bouncer view defaults to the type of table the user was previously working on, allowing the user to continue the same job on a new batch.

14. The computer-readable media of claim 12, further comprising:
receiving an input indicating that an identifier has been scanned; and
navigating to a specific step in the process phase according to the scanned identifier.

15. The computer-readable media of claim 12, wherein the loop bouncer is customizable, and is configurable to navigate to those process phases that are currently running, or are currently having problems, or meet another specified criteria established by the user.

16. A system for iteratively collecting data in a first manner and transforming the collected data for presentation in a second different manner, the system comprising:
a hardware processor;
system memory;
a software instantiator configured to instantiate a software application that tracks progress of a manufacturing process;
a data collector configured to iteratively collect data at the software application, wherein the data corresponds to inputs from a first set of one or more workers associated with the manufacturing process, the inputs being related to a specified iteration of a process phase, the inputs being provided in a first manner that is expected by the first set of workers;
a receiver configured to receive a request to present the iteratively collected data in a second, different manner;
a representation generator configured to generate a representation of the iteratively collected data in the second different manner, the representation comprising a report on the specified iteration of the manufacturing process phase; and
a data presenter configured to present the report to a second, different set of one or more workers, allowing the second set of workers to consume the report in the second manner expected by the second set of workers.

17. The system of claim 16, wherein the software application supports multiple simultaneous users across a plurality of unit procedures.

18. The system of claim 16, wherein the software application allows users to make corrections or add samples to a manufacturing process phase.

19. The system of claim 16, wherein the software application allows workers to select a workflow and see one or more details related to that workflow.

20. The system of claim 16, wherein the software application allows the first set of workers to avoid tabular input systems.
